(19) United States
(12) Patent Application Publication
(10) Pub. No.: US 2018/0331596 A1
(43) Pub. Date: Nov. 15, 2018

(54) ELECTROMECHANICAL ASSEMBLY COMPRISING AN ELECTRIC MACHINE COUPLED TO A REDUCING GEAR

(71) Applicant: MOTEURS LEROY-SOMER, Angouleme (FR)

(72) Inventors: Didier CALMETTES, Puymoyen (FR); Pascal PONT, Champniers (FR); Stéphane NOIREAU, Mouthiers Sur Boheme (FR)

(73) Assignee: MOTEURS LEROY-SOMER, Angouleme (FR)

(21) Appl. No.: 15/775,974

(22) PCT Filed: Nov. 7, 2016
(86) PCT No.: PCT/EP2016/076870

§ 371 Date: May 14, 2018

(30) Foreign Application Priority Data
Nov. 12, 2015 (FR) 1560788

(51) Int. Cl. H02K 7/116; H02K 15/16; H02K 7/00; F16H 57/00

(52) U.S. Cl. CPC H02K 7/116; F16H 57/0025; H02K 7/003; H02K 15/16

(57) ABSTRACT

An electromechanical assembly including an electric machine coupled to a reducing gear, the electric machine including two bearings or rollers, the reducing gear including two bearings or rollers, the reducing gear and the electric machine each including a housing including means for attachment to the other housing, the electric machine and the reducing gear each including a shaft engaged in the other, each shaft including centring projections produced in such a way that the mutual engagement of the shafts has a centring effect that positions the housings correctly in order for them to be attached by means of the attachment means.

The present invention relates to the electromechanical assemblies comprising an electric machine and a reducing gear, and more particularly but not exclusively those in which the electric machine is a motor, particularly a car drive motor.

It is known to assemble an electric motor and a reducing gear by means of a splined connection, one of the shafts being a male shaft and the other a female shaft, which is typically a shaft having a hollow end part in which a bushing is shrunk.

In order to allow the shafts to be assembled, it is known to leave a clearance at the splines, which is a source of wear and noise. The motor may comprise only one rolling bearing at the rear, the shaft of the motor being guided at the front by the shaft of the reducing gear, which may be supported by two rolling bearings.

The splines of the male shaft are generally cut directly therein while those of the female shaft are machined in the bushing.

To reduce the tendency of the splines to misalign in operation under the effect of the radial force related to the magnetic forces of the electric machine and of the splines to generate fretting corrosion wear, it is known to add a centering seat between the male shaft and the female shaft in front of the splines. The clearance conventionally present for mounting the shafts at the centering seat is approximately 5 to 35 μm, which allows a misalignment angular displacement of approximately 0.06° to 0.4°. This displacement results in wear of the splines which forms a source of noise and of wear negatively impacting the lifetime of the assembly.

In order to dampen the displacement between the male and female shafts, it is known from the publications U.S. Pat. No. 3,686,895 and CN 102644636 to radially insert damping elements such as O-rings at the splines, or at a centering cylindrical seat.

In another known embodiment, and still assuming spline wear kinematics related to the clearance required for mounting the splines, the reducing gear is equipped with a shaft mounted on two rolling bearings while the motor comprises only one rolling bearing at the rear, without any flange or rolling bearing at the front. In this configuration, the coupling is produced by splines made in a female bushing shrunk into the motor shaft and splines cut on the male shaft of the reducing gear also requiring a centering seat.

Since the motor has only one rolling bearing at the rear, the magnet rotor exerts a radial force that will generate a misalignment of the splines leading to, in operation, a fretting corrosion wear.

In order to operate without noise, the shafts of the motor and reducing gear need to rotate with the smallest possible co-axiality and concentricity defects. The radial clearance at the centering seat which allows an angular displacement leads to wear of the splines by a so-called “fretting corrosion” phenomenon which does not make it possible to provide the expected lifetime.

A known solution consists in designing a motor with two bearings, which motor will be coupled to a reducing gear with two bearings. The reducing gear and motor shafts comprise splines at the ends thereof. The connection between the shafts is produced via a splined sleeve. This mounting requires rigorous positioning of the two casings, which is carried out for example by locating pins, which affects the cost and may create installation constraints.

The aim of the invention is to reduce the operating noise of a geared electric machine without necessarily making the machine excessively more complex or increasing the difficulties in assembling the motor and the reducing gear or in arranging the machine in the environment of use thereof.

It achieves this through an electromechanical assembly comprising an electric machine coupled to a reducing gear, the electric machine comprising two bearings or rolling bearings, the reducing gear comprising two bearings or rolling bearings, the reducing gear and the electric machine each comprising a casing comprising means for fixing to the other casing, the electric machine and the reducing gear each comprising a shaft engaged in the other, each shaft comprising centering protrusions produced in such a way that fitting the shafts together has a centering effect so that the casings are positioned correctly for the fixing thereof using the fixing means.

Thanks to the invention, it is firstly possible to fit the shafts together, then fix the casings together, in the position taken by the latter when the shafts are fitted together.

The centering protrusions may be made with zero clearance, thereby limiting noise. In addition, the assembly according to the invention may comprise only fixing means such as screws, bolts, for fixing the casings one on the other, without having to produce, on the casings, protrusions for precise positioning of one casing relative to the other.

The centering protrusions may be splines.

These splines may have a geometry making it possible to center the fitting between the shafts via the sides. The profiles of the splines of a shaft are advantageously produced in such a way as to be in contact with the splines of the other shaft, once the shafts are fitted together, without clearance.

Either the electric machine or the reducing gear may comprise a male shaft and the other a female shaft. The centering protrusions of the female shaft may be produced in a bushing attached in the female shaft. The female shaft may be the shaft of the electric machine.

The electric machine may be a motor, which may have a rotational speed between 1000 and 18000 rpm.

The motor may be a car drive motor.

The invention also relates to a method of fixing an electromechanical assembly as described above, the method comprising the following steps:
fitting together the shafts of the electric machine and of the reducing gear via the centering protrusions until bringing the casings into contact with each other,
fixing the casings together via the fixing means in the position that they have taken in the preceding fitting step.

The invention may be better understood on examining the appended drawing, illustrating a detailed embodiment, in which:

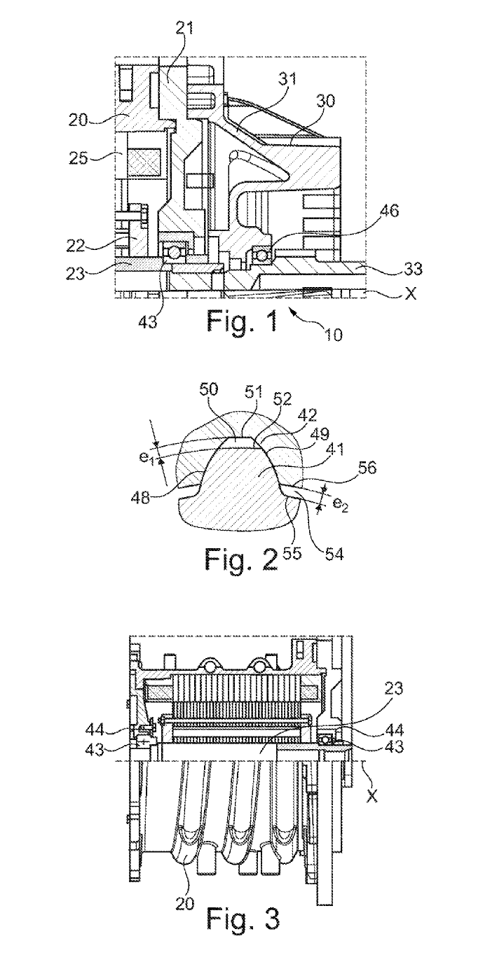

FIG. 1 shows, schematically, partially and in axial section, an electromechanical assembly according to the invention,

FIG. 2 shows, schematically, partially and in cross-section, the fitting between two protrusions of the shaft of the reducing gear and of the shaft of the electric machine, respectively,

FIG. 3 shows, in a schematic and isolated manner, partly in perspective and partly in axial section, the electric machine of the electromechanical assembly of FIG. 1, and

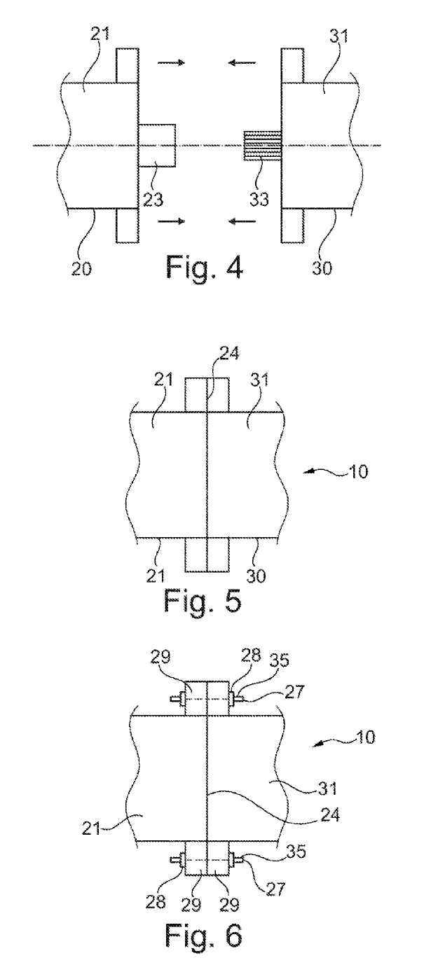

FIGS. 4 to 6 illustrate the various steps of the method for assembling and fixing the electromechanical assembly according to the invention.

The assembly 10 shown in FIG. 1 comprises an electric machine 20 and a reducing gear 30 coupled to the machine 20. The machine 20 and the reducing gear 30 comprise respective casings 21 and 31, which are assembled and fixed together. The machine 20 is, in the example in question, an electric motor and comprises a rotor 22, the shaft 23 of which rotates about an axis X. The rotor 22 is internal to a stator 25. The machine 20 may be a permanent magnet motor. The shaft 23 is supported by two rolling bearings 43, carried by flanges 44 of the machine 20.

The reducing gear 30, which may be seen in FIG. 1, comprises an input shaft 33 which is guided at the front and rear by respective rolling bearings, a rolling bearing 46 of which may be seen in FIG. 1.

In the illustrated example, all of the rolling bearings are ball bearings but may be another type without departing from the scope of the invention. In particular, the rolling bearings may be optionally-tapered roller bearings, needle bearings, etc.

A mechanical connection, shown more particularly in FIGS. 2 and 3, transmits the torque between the shafts 23 and 33. Each shaft 23 or 33 comprises centering protrusions produced in such a way that the shafts 23 and 33 are fitted together without clearance. The casings 21 and 31 are fixed together by the fixing means 35 in the position set by the shafts being fitted together. The fixing means 35 are composed, in the illustrated example, by screws and/or nuts and bolts or other fixing means of the same type.

In the illustrated example, the shaft 23 of the electric machine 20 is a female shaft in which a bushing 40 has been shrunk, the bushing 40 internally comprising the centering protrusions 42 consisting of female splines.

The male shaft is made up by the shaft 33 of the reducing gear 30 having, at the end 34 thereof, the centering protrusions 41 consisting, in the illustrated example, of male splines extending along the axis X.

A male spline 41 fitted together with a female spline 42 has been shown in FIG. 2.

As may be seen in this figure, the centering between the shafts 23 and 33 takes place via the sides 48 and 49 of the splines 41 and 42. No clearance is provided between the splines, as may be seen, such that the wear and noise related to the clearance may be avoided. It should be noted that a space 50 is, however, provided between the base 51 of the female spline 42 and the end 52 of the male spline 41, with a smallest possible width e₁ in order to make it possible to ensure, regardless of the manufacturing tolerances, that there is a zero clearance between the splines. Likewise, a space 54 is provided between the base 55 of the male spline 41 and the end 56 of the female spline 42, with a smallest possible width e₂ make it possible to ensure, regardless of the manufacturing tolerances, that there is a zero clearance between the splines.

Thus, by virtue of the invention and the presence of both rolling bearings at the motor, it is possible to produce a clearance-free fitting between the shafts 23 and 33 and to allow, by this fitting-together, the correct positioning of the casings 31 and 21 with respect one another, and then the fixing thereof in this same position using the fixing means, without any other connecting element.

FIGS. 4 to 6 show the method of fixing the electromechanical assembly 10.

The first step illustrated in FIG. 4 consists in bringing the machine 20 and the reducing gear 30 closer together so as to allow the shaft 33 of the reducing gear 30 and the shaft 23 of the machine 20 to be fitted together.

In the second step as illustrated in FIG. 5, the casings 21 and 31 are squeezed together so as to bring them into contact along a contact surface 24. The positioning or orientation of the casings 21 and 31 with respect to one another is not changed.

Finally, still in the position taken by the cases 21 and 31 when the shafts 23 and 33 are fitted together in the first step, the casings 21 and 31 are fixed together, as illustrated in FIG. 6, using the fixing means 35 formed, in this example, from threaded rods 27 and bolts 28 through brackets 29.

The invention is not limited to the example that has just been described.

The female shaft of the electric machine may be replaced by a male shaft, and vice versa.

An intermediate element, such as a joint, may be inserted between the casings without departing from the scope of the invention.

The rolling bearings or some rolling bearings may be replaced by plain bearings without departing from the scope of the invention.

1. An electromechanical assembly comprising an electric machine coupled to a reducing gear,
the electric machine comprising two bearings or rolling bearings,
the reducing gear comprising two bearings or rolling bearings,
the reducing gear and the electric machine each comprising a casing comprising means for fixing to the other casing,
the electric machine and the reducing gear each comprising a shaft engaged in the other, each shaft comprising centering protrusions produced in such a way that fitting the shaft together has a centering effect so that the casings are positioned correctly for the fixing thereof using the fixing means.

2. The assembly as claimed in claim 1, comprising only the fixing means for fixing the casings one on the other.

3. The assembly as claimed in claim 1, wherein the centering protrusions are splines.

4. The assembly as claimed in claim 3, wherein the splines have a geometry making it possible to center the fitting between the shafts via the sides.

5. The assembly as claimed in claim 3, wherein the profiles of the splines of a shaft are produced in such a way as to be in contact with the splines of the other shaft, once the shafts are fitted together, without clearance.

6. The assembly as claimed in claim 1, wherein either the electric machine or the reducing gear comprises a male shaft and the other a female shaft.

7. The assembly as claimed in claim 6, the centering protrusions of the female shaft being produced in a bushing attached in the female shaft.

8. The assembly as claimed in claim 6, wherein the female shaft is the shaft of the electric machine.

9. The assembly as claimed in claim 1, wherein the electric machine is a motor, with a rotational speed between 1000 and 18000 rpm.

10. The assembly as claimed in claim 9, the motor being a car drive motor.

11. A method of fixing an electromechanical assembly as claimed in claim 1, the method comprising the following steps:
fitting together the shafts of the electric machine and of the reducing gear via the centering protrusions until bringing the casings into contact with each other,
fixing the casings together via the fixing means in the position that they have taken in the preceding fitting step.
